(19) United States
(12) Patent Application Publication
(10) Pub. No.: US 2007/0297177 A1
(43) Pub. Date: Dec. 27, 2007

(54) Modular lamp structure

(76) Inventors: Bily Wang, Hsin Chu City (TW); Jonnie Chuang, Pan-Chiao City (TW); Shih-Yu Wu, Pan Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/475,146

(22) Filed: Jun. 27, 2006

(51) Int. Cl. F21V 29/00

(52) U.S. Cl. 362/294

(57) ABSTRACT

A modular lamp structure includes a housing, a base, an illumination module, and a control module. The housing has a receiving space. The base is disposed in the receiving space, the base including one end and other end. The illumination module is disposed on the one end of the base, and the control module is disposed on the other end of the base, the control module is connected electrically to the illumination module; Thereby the housing is dissipated heat from the lamp module.

### BACKGROUND OF THE INVENTION

1. Field of the Invention

The present invention relates to a lamp structure, and more particularly, to a modular lamp structure.

2. Description of Related Art

Halogen lamps include a luminescence module and an electronic module. A luminescence module includes a lampshade and a luminescent member. The illumination wattage of the halogen lamp is determined by the electronic module's size. The larger the electronic module, the larger the illumination wattage of the halogen lamp may be. However, the halogen lamp has a small receiving space, and can't receive larger electronic modules. Hence, the illumination wattage of the halogen lamp is very limited.

Moreover, halogen lamps are usually illuminated for long periods. In this time they produce large amounts of heat energy, yet lack a heat-dissipating device. This leads to a short user life, and is inconvenient for users.

Furthermore, the angle and scope of the illumination of the halogen lamp are fixed, so using the halogen lamp is often inconvenient for users.

Accordingly, as discussed above, the prior art still has some drawbacks that could be improved. The present invention aims to resolve the drawbacks in the prior art.

### SUMMARY OF THE INVENTION

An object of the present invention is to provide a modular lamp structure, the heat of the lamp is dissipated by a heat-dissipating housing.

Another object of the invention is to provide a modular lamp structure, the illumination module and the control module are separated by a base, and hence the lamp has a larger space available for receiving larger control modules than was possible in the prior art. The illumination wattage of the lamp can thereby be increased. This allows the user to adjust the brightness and scope of the illumination module in both a convenient and easy manner.

A further object of the invention is to provide a modular lamp structure, the position of the lamp module is adjusted by an adjusting unit, and hence the angle and scope of illumination is adjustable.

For reaching the objects above, the present invention provides a modular lamp structure that includes a housing having a receiving space, a base disposed in the receiving space, the base including two ends, an illumination module disposed on one end of the base, and a control module disposed on the other end of the base, the control module being electrically connected to the illumination module.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an exploded perspective view of a modular lamp structure of the present invention;

FIG. 2 is a perspective view of a modular lamp structure of the present invention;

FIG. 3 is a cross-sectional view of a modular lamp structure of the present invention (1); and

FIG. 4 is a cross-sectional view of a modular lamp structure of the present invention (2).

### DETAILED DESCRIPTION OF PREFERRED EMBODIMENTS

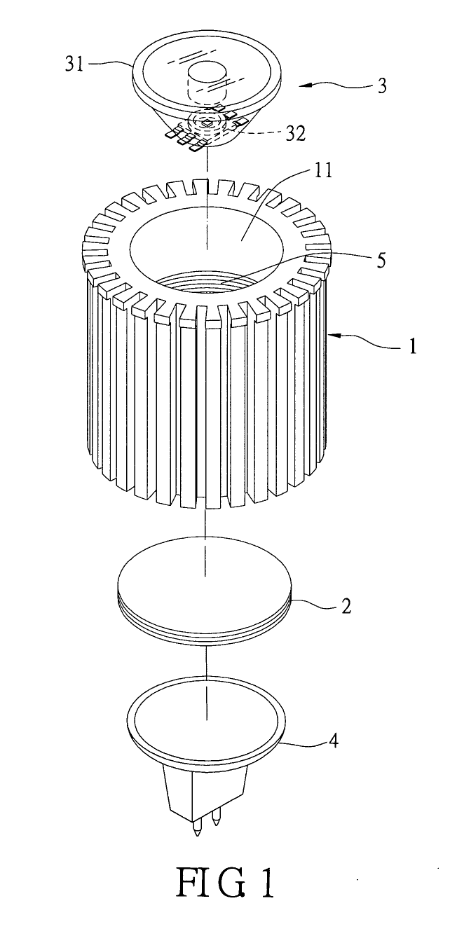

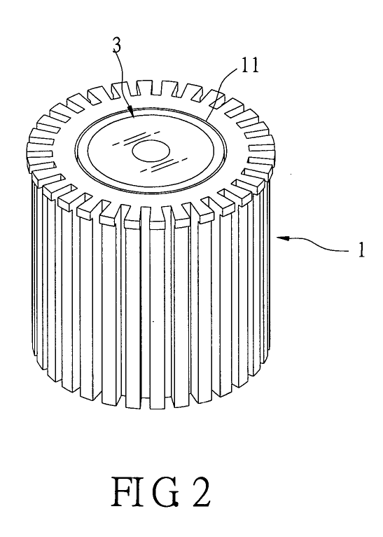

Reference is made to FIG. 1 and FIG. 2. The present invention of a modular lamp structure includes a housing 1, a base 2, an illumination module 3, and a control module 4. The housing 1 has a receiving space 11 and has fins formed on its exterior side. The housing 1 is a heat-dissipating housing for dissipating the heat generated by the lamp. The housing 1 is cylinder-shaped (it can also be any other shape). The base 2 is disposed in the receiving space 11 and has grooves that act as a screw formed on its side. The illumination module 3 and the control module 4 are separated by the base 2. The base 2 includes one end and one other end. Inside the housing 1 there is an adjusting unit 5, and the base 2 connects to the adjusting unit 5, hence the position of the base 2 is moved via the adjusting unit 5.

The illumination module 3 is disposed on the one end of the base 2. The illumination module 3 includes a lampshade 31 and a luminescent member 32. The lampshade 31 is a reflection lampshade or a lens. The luminescent member 32 is a light emitting diode (LED). The control module 4 is disposed on the other end of the base 2. The control module 4 is connected electrically to the illumination module 3. The control module 4 includes a circuit, a resistance, capacitance, and so on. The illumination module 3 and the control module 4 are separated by the base 2. Hence the lamp has a bigger space for receiving the control module 4. The illumination wattage of the lamp is increased. This allows the user to adjust the brightness and scope of the illumination module in both a convenient and easy manner.

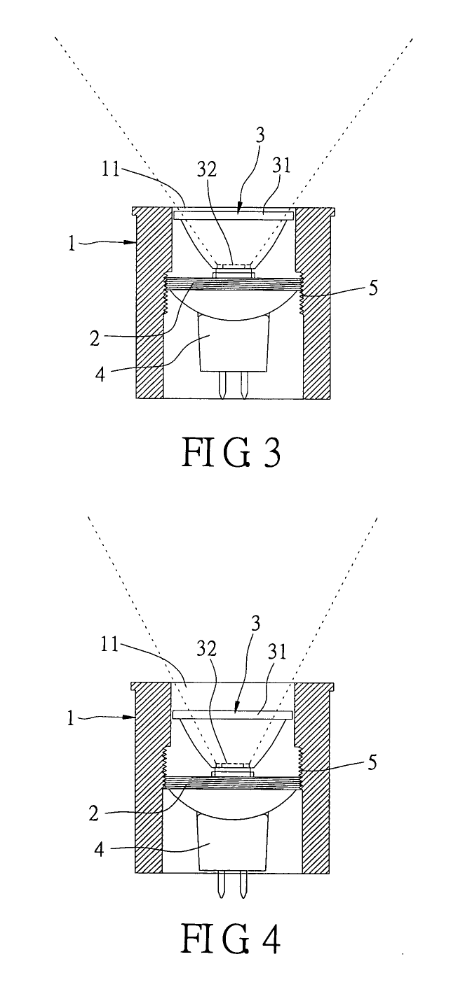

Referring to FIG. 3 and FIG. 4 the illumination module 3 is disposed on the one end of the base 2, the control module 4 is disposed on the other end of the base 2. The base 2 is connected on the adjusting unit 5. The base 2 is moved by moving the adjusting unit 5. As the base 2 is moved upward by the adjusting unit 5 (FIG. 3), the angle of the illumination module 3 becomes smaller, and hence the scope of the illumination becomes bigger. If the base 2 is moved downward by the adjusting unit 5 (FIG. 4), the angle of illumination module 3 becomes bigger, and hence the scope of the illumination becomes smaller. The present invention allows adjusting of the position of the lamp module by the adjusting unit 5. Thereby the angle and scope of illumination can be adjusted.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

1. A modular lamp structure, comprising:
a housing having a cavity formed therein and a plurality of fins on an outer surface thereof;
a base disposed in said cavity of said housing, the base including a threaded outer surface;
an illumination module disposed in said cavity of said housing and coupled to a first end of the base; and
a control module disposed in said cavity of said housing and coupled to an opposing second end of the base, the control module connected electrically to the illumination module.

2. The structure as claimed in claim 1, wherein the housing is a heat-dissipating housing.

3. (canceled)

4. The structure as claimed in claim 1, wherein the housing has a displaceable an adjusting unit on an inner surface thereof, where said base is coupled to said adjusting unit and displaceable responsive to displacement of said adjusting unit.

5. (canceled)

6. The structure as claimed in claim 1, wherein the illumination module further comprising a lampshade, the lampshade is a reflection lampshade or a lens.

7. The structure as claimed in claim 1, wherein the illumination module further comprising a luminescent member, the luminescent member is a light emitting diode (LED).
